(19) United States
(12) Patent Application Publication
(10) Pub. No.: US 2012/0306684 A1
(43) Pub. Date: Dec. 6, 2012

(54) RADAR EQUIPMENT AND RECEIVED DATA PROCESSING METHOD

(76) Inventor: Yoshikazu SHOJI, Kawasaki-shi (JP)

(21) Appl. No.: 13/489,769

(22) Filed: Jun. 6, 2012

(30) Foreign Application Priority Data
Jun. 6, 2011 (JP) 2011-126736

(51) Int. Cl. G01S 13/58

(52) U.S. Cl. 342/107

(57) ABSTRACT

According to one embodiment, a radar equipment includes a signal processor, a first and second estimation module and an integration module. The signal processor generates first data based on range bin data. The first estimation module estimates a present position of a target based on second data, and shifts the second data to the estimated position to generate third data. The second estimation module estimates the present position based on first data of an n^{th} previous scan, and shifts the first data of the n^{th} previous scan to the estimated position to generate fourth data. The integration module adds the third data to, and subtracts the fourth data from first data obtained by the present scan to generate second data.

### CROSS-REFERENCE TO RELATED APPLICATIONS

This application is based upon and claims the benefit of priority from prior Japanese Patent Application No. 2011-126736, filed Jun. 6, 2011, the entire contents of which are incorporated herein by reference.

### FIELD

Embodiments described herein relate generally to a radar equipment and a received data processing method.

### BACKGROUND

A radar equipment receives pulse signals, which are transmitted at predetermined pulse repetition interval (PRI) as a plurality of outgoing pulses and reflected, scattered, or diffracted. The radar equipment performs incoherent integration on the received pulse signals. The coherent integration is an operation of coherently integrating a plurality of pulse signals in the same range. Generally, the period in which the radar equipment performs coherent integration on the received pulse signals is called coherent processing interval (CPI). The radar equipment performs incoherent integration on a coherent integration result of a present scan and a coherent integration result of a past scan, and measures the strength of the incoherent integration result. If the measured strength exceeds a predetermined threshold, the radar equipment determines that a target is present in the location.

However, since a radar equipment of this type performs incoherent integration on coherent integration results obtained by past scans, if a noise signal exceeding a threshold value is generated, influence of the noise signal remains in the subsequent measurements. The influence appears on a scope as a false track indicating that a target is moving, and causes false detection of a target.

### BRIEF DESCRIPTION OF THE DRAWINGS

FIG. 1 is a block diagram showing a functional configuration of a radar equipment according to a first embodiment.

FIG. 2 shows pulse compression processing performed by the pulse compressor shown in FIG. 1.

FIG. 3 shows coherent integration performed by the Doppler filter processor shown in FIG. 1.

FIG. 4 shows parameters of four-parameter data generated by the signal processor shown in FIG. 1.

FIG. 5 shows parameters used in a simulation for the radar equipment shown in FIG. 1.

FIG. 6 shows an outline of sliding window processing at the integration module shown in FIG. 1.

FIG. 7 shows a simulation result of a case where the simulation parameters shown in FIG. 5 are used.

FIG. 8 shows a simulation result of a case where the sliding window processing shown in FIG. 6 is not applied.

FIG. 9 is a block diagram of a functional configuration of a MIMO radar system including the radar equipment according to the first embodiment.

FIG. 10 is a block diagram showing another functional configuration of the radar equipment shown in FIG. 9.

FIG. 11 is a block diagram showing a functional configuration of a radar equipment according to a second embodiment.

FIG. 12 is a graph based on which a weighting coefficient for the weighting module shown in FIG. 11 is calculated.

FIG. 13 is a block diagram showing another functional configuration of the radar equipment according to the second embodiment.

### DETAILED DESCRIPTION

In general, according to one embodiment, a radar equipment includes a radio transmitter, a pulse compressor, a Doppler filter processor, a signal processor, a first estimation module, a second estimation module and an integration module. The radio transmitter receives pulse signals. The pulse compressor performs pulse compression on the pulse signals to generate range bin data for each of the pulse signals. The Doppler filter processor performs Doppler filter processing on the range bin data to generate range bin data for each frequency bin. The signal processor generates first data indicating a state of a predetermined search area using parameters including a velocity of a target, based on the range bin data for each frequency bin obtained by one scan to the search area. The first estimation module estimates a position of the target at a time of a present scan based on second data obtained by integrating first data of a predetermined number n of most recent previous scans, and shifts the second data to the estimated position to generate third data. The second estimation module estimates a position of the target at the time of the present scan based on first data obtained by an n^{th} previous scan, and shifts the first data of the n^{th} previous scan to the estimated position to generate fourth data. The integration module adds the third data to first data obtained by the present scan to generate addition data, and subtracts the fourth data from the addition data to generate second data.

### First Embodiment

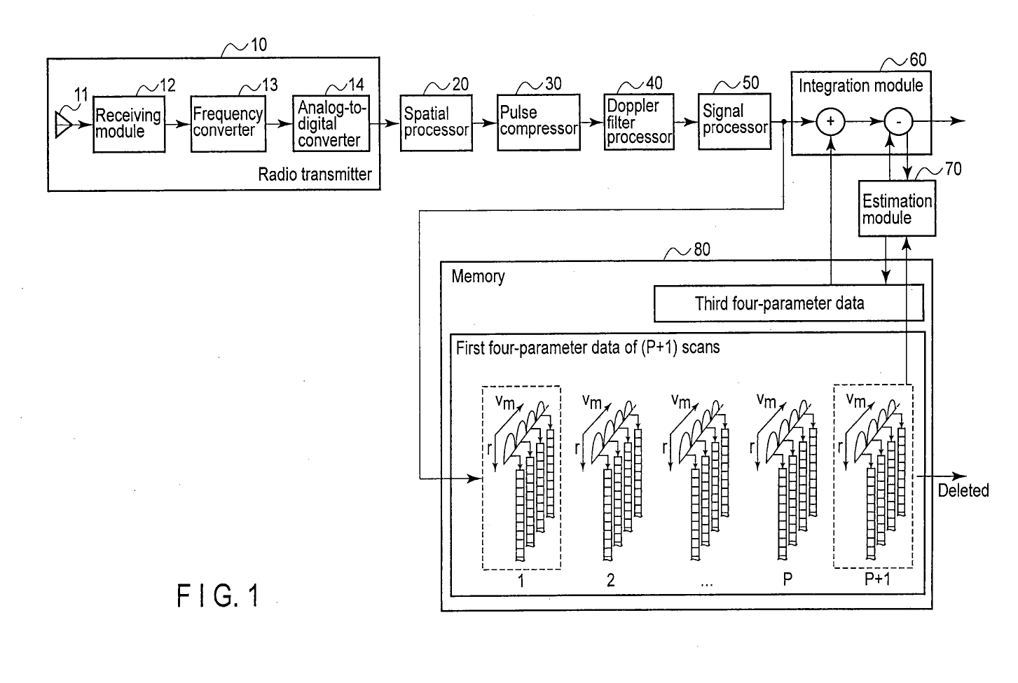

FIG. 1 is a block diagram showing a functional configuration of a radar equipment according to a first embodiment. The radar equipment shown in FIG. 1 comprises a radio transmitter 10, a spatial processor 20, a pulse compressor 30, a Doppler filter processor 40, a signal processor 50, an integration module 60, an estimation module 70, and a memory 80. In this embodiment, explained as an example is a case where M outgoing pulses are transmitted from a transmitter (not shown) per one beam position in a fixed coherent processing interval (CPI). The outgoing pulses are transmitted at fixed pulse repetition interval (PRI).

The radio transmitter 10 comprises an antenna element 11, a receiving module 12, a frequency converter 13 and an analog-to-digital converter 14. The antenna element 11 receives M pulse signals, which are transmitted as outgoing pulses and reflected, scattered, or diffracted. The antenna element 11 outputs each received pulse to the receiving module 12. The receiving module 12 amplifies the power of the received pulse supplied from the antenna element 11.

The frequency converter 13 converts the received pulse amplified at the receiving module 12 into a pulse in a base band. The analog-to-digital converter 14 digitizes the received pulse supplied from the frequency converter 13, and outputs the digitized received pulse to the spatial processor 20.

The spatial processor 20 applies a predetermined beam weight to the received pulse digitized at the radio transmitter 10 to form a reception beam.

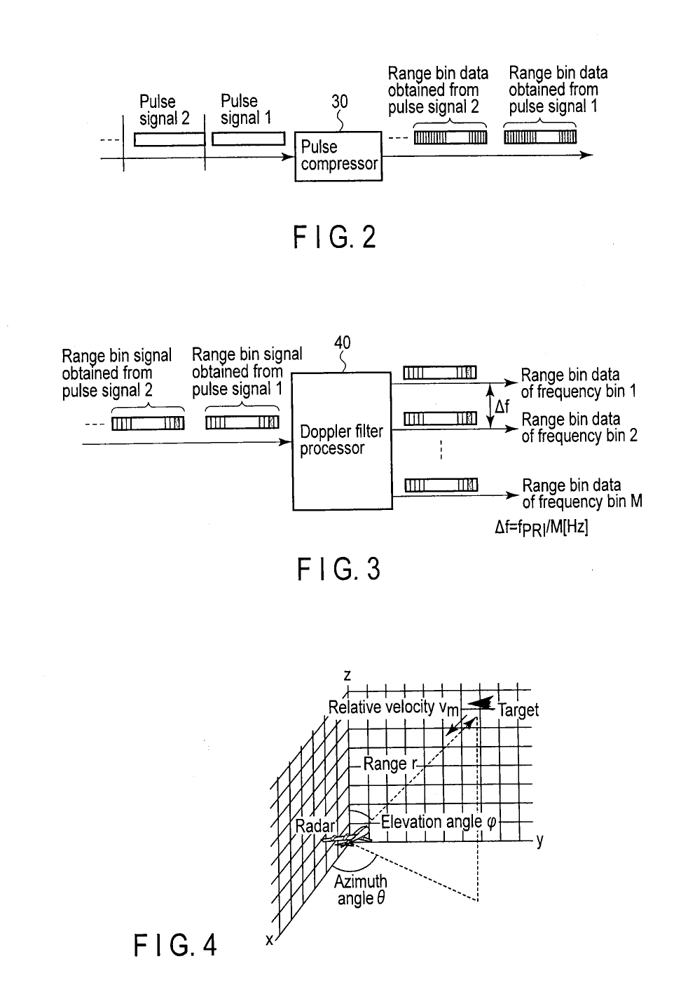

The pulse compressor 30 performs pulse compression processing on the received pulse supplied from the spatial processor 20 to generate range bin data for each received pulse. FIG. 2 is a schematic diagram of pulse compression processing performed by the pulse compressor 30. The pulse compressor 30 outputs the generated range bin data to the Doppler filter processor 40.

The Doppler filter processor 40 performs coherent integration on a set of M range bin data items supplied from the pulse compressor 30 during one CPI. Namely, the Doppler filter processor 40 performs FFT processing on range bin data supplied from the pulse compressor 30 during one CPI, thereby generating range bin data for each of M frequency bins. The frequency bin is each of frequency band divisions having a predetermined bandwidth. FIG. 3 is a schematic diagram of coherent integration performed by the Doppler filter processor 40. The Doppler filter processor 40 outputs the generated range bin data to the signal processor 50.

Based on the range bin data supplied from the Doppler filter processor 40, the signal processor 50 makes the status of a predetermined search area expressed by range r, azimuth angle θ, elevation angle φ, and relative velocity vₘ. Namely, the signal processor 50 generates first four-parameter data so that the amplitude values of all range bin data obtained by one omnidirectional scan can be identified by range r, azimuth angle θ, elevation angle φ, and relative velocity vₘ. First four-parameter data obtained by scan i is expressed by R⁽ⁱ⁾(r, θ, φ, vₘ).

The signal processor 50 outputs the generated first four-parameter data to the integration processor 60 and the memory 80. FIG. 4 is a schematic diagram showing the relationship between range r, azimuth angle θ, elevation angle φ, and relative velocity vₘ. Described herein is a case where an amplitude value of range data is identified by range r, azimuth angle θ, elevation angle φ, and relative velocity vₘ. However, a power value of range data may be identified by range r, azimuth angle θ, elevation angle φ, and relative velocity vₘ.

The relative velocity vₘ of a target in the m^{th} frequency bin (where m is a natural number from 1 to M) is obtained based on M pulse signals transmitted during 1CPI as described below. The frequency bandwidth Δf of each frequency bin shown in FIG. 3 is expressed as Δf=f_{PRF}/M. f_{PRF} is 1/T_{PRI}, where T_{PRI} represents a PRI. Assuming that the value of each frequency bin varies only depending on change in the Doppler frequency caused by movement of the target, the relative velocity vₘ(m) in the m^{th} frequency bin is expressed by vₘ(m)=m·Δf·c/fc, where c represents the speed of light, and fc represents a carrier frequency.

When the estimation module 70 receives second four-parameter data (to be described later) from the integration module 60, the estimation module 70 assumes that a target is present in all the elements of second four-parameter data. The estimation module 70 estimates a range bin in which the target would be present when a next scan is performed, on the basis of the relative velocity, which is a parameter of the second four-parameter data. The range bin is each of search area divisions having a predetermined range. The processing at the estimation module 70 will be described below.

The radar equipment receives reflection waves of outgoing pulses sequentially transmitted in all the directions in a predetermined search area. Namely, a pulse signal is received discretely (at scan intervals) in the same direction. When a scan is performed every T_{SCAN} seconds, range bin data of each frequency bin 1-M shown in FIG. 3 is obtained every T_{SCAN} seconds.

When it is assumed that a target moves with uniform linear motion, a target present in frequency bin m is estimated to be at a distance of vₘ(m)·T_{SCAN} at the time of the next scan which is performed T_{SCAN} seconds later. Namely, when the interval between adjacent range bins is x, the target moves by range bins, the number of which is the maximum integer An not more than vₘ(m)·T_{SCAN}/x.

If a target is present in range bin r, frequency bin m at the time of the ith scan, the target is estimated to be present in range bin r+Δn (m), frequency bin m at the time of the (i+1)^{th} scan, which is performed T_{SCAN} seconds later.

The estimation module 70 shifts second four-parameter data to the estimated range bin to generate third four-parameter data. The estimation module 70 outputs the generated third four-parameter data to the memory 80.

The estimation module 70 receives first four-parameter data recorded at the time of a predetermined p^{th} previous scan (where p is a natural number). The estimation module 70 estimates a range bin in which a target would be present at the time of the p^{th} next scan (T_{SCAN}×p seconds later), i.e., the present scan. The estimation module 70 shifts the first four-parameter data recorded at the time of the p^{th} previous scan to the estimated range bin to generate fourth four-parameter data. The estimation module 70 outputs the generated fourth four-parameter data to the integration module 60.

The memory 80 receives first four-parameter data supplied from the signal processor 50. The memory 80 stores the (p+1) first four-parameter data items supplied from the signal processor 50. More specifically, the memory 80 first stores first four-parameter data items of the first to p^{th} scans, which are supplied from the signal processor 50. After storing the (p+1)^{th} first four-parameter data item at the time of the (p+1)^{th} scan, the memory 80 outputs the first four-parameter data item stored at the time of the first scan to the estimation module 70, and deletes the first four-parameter data item stored at the time of the first scan. If a first four-parameter data item is obtained at the time of a (p+2)^{th} or later scan, the memory 80 outputs the first four-parameter data item stored at the time of the p^{th} previous scan to the estimation module 70, and deletes the first four-parameter data item stored at the time of the p^{th} previous scan.

The memory 80 also stores third four-parameter data supplied from the estimation module 70. The memory 80 outputs stored third four-parameter data to the integration module 60 in accordance with read instructions from the integration module 60.

At the time of the first scan, the integration module 60 outputs first four-parameter data supplied from the signal processor 50 to the subsequent stage and the estimation module 70 as second four-parameter data.

At the time of each of the second to p^{th} scan, upon receipt of first four-parameter data from the signal processor 50, the integration module 60 reads out from the memory 80 third four-parameter data generated based on the previous scan. The integration module 60 integrates the first four-parameter data supplied from the signal processor 50 with the third four-parameter data read out from the memory 80 to generate second four-parameter data. The integration module 60 outputs the generated second four-parameter data to the subsequent stage and the estimation module 70.

At the time of a (p+1)^{th} or later scan, the integration module 60 integrates the first four-parameter data supplied from the signal processor 50 with the third four-parameter data supplied from the memory 80. Then, the integration module 60 subtracts fourth four-parameter data supplied from the estimation module 70 from the integration result to generate second four-parameter data. Hereinafter, this processing performed by the integration module 60 will be referred to as sliding window processing.

The radar equipment may further comprise a target detector in the stage subsequent to the integration module 60, although it is not shown in FIG. 1. The target detector receives second four-parameter data from the integration module 60, and determines whether the amplitude value of the received second four-parameter data exceeds a threshold value. The threshold value varies depending on the number of incoherent integration operations at the integration module 60. When the amplitude value of second four-parameter data exceeds the threshold, the target detector determines that a target has been detected.

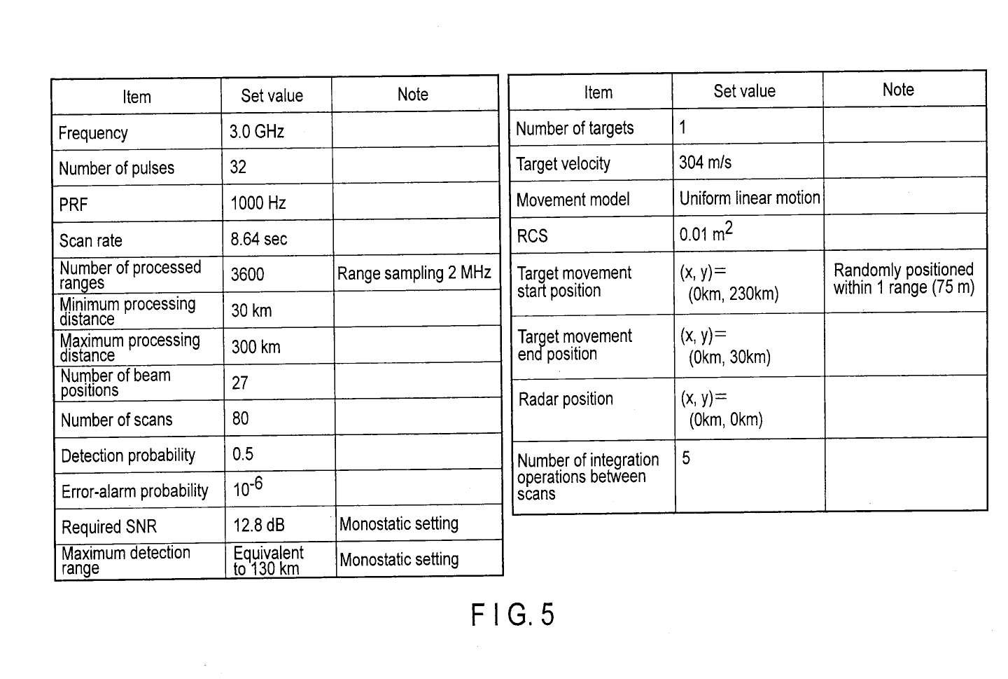

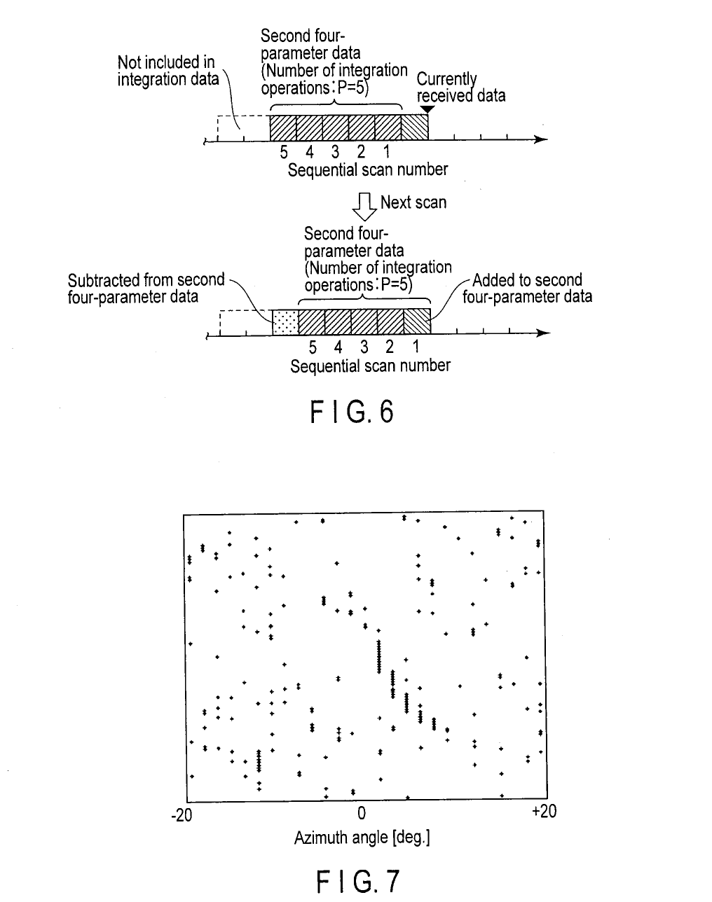

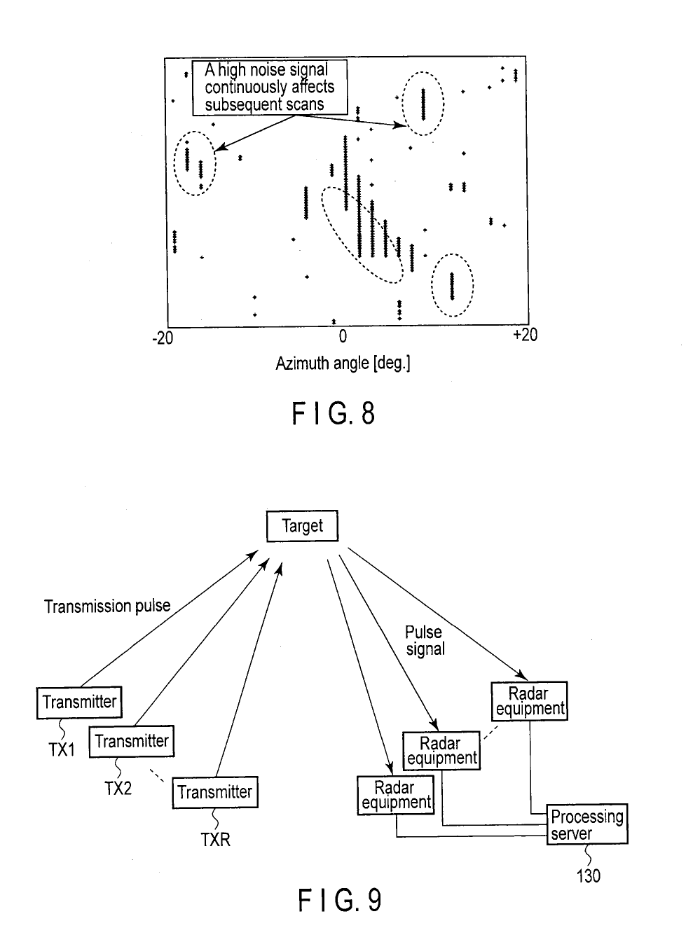

Next, a simulation result of change in the detection probability of the radar equipment having the above-described configuration will be described. FIG. 5 shows parameters used in a simulation for the radar equipment according to the first embodiment. In this simulation, the number p of incoherent integration operations is 5. FIG. 6 is a schematic diagram showing an outline of the sliding window processing performed at the integration module 60 when p is 5. FIG. 7 shows a simulation result of change in the detection probability calculated using the parameters shown in FIG. 5. FIG. 8 shows a simulation result of change in the detection probability calculated without applying the sliding window processing. In FIG. 8, the broken line circles each indicate false detection of a target caused because of a noise signal. FIG. 7 shows no false detection because the sliding window processing prevents false detection as indicated in FIG. 8.

As described above, in the first embodiment, when integration of first four-parameter data is performed a predetermined p times or more, the integration module 60 subtracts fourth four-parameter data estimated based on the first four-parameter data obtained by the p^{th} previous scan from the integration result. Namely, the number of incoherent integration operations is limited to a predetermined number. Therefore, continuous effect of a past high noise signal on search processing in later scans can be suppressed.

Consequently, the radar equipment according to the first embodiment can suppress effect of a noise signal occurred in a past scan, and correctly detect the position of a target.

Described in the first embodiment is the case where the signal processor 50 converts range bin data supplied from the Doppler filter processor 40 into first four-parameter data. However, the radar equipment may have different configurations. For example, the radar equipment may form a MIMO radar system as shown in FIG. 9.

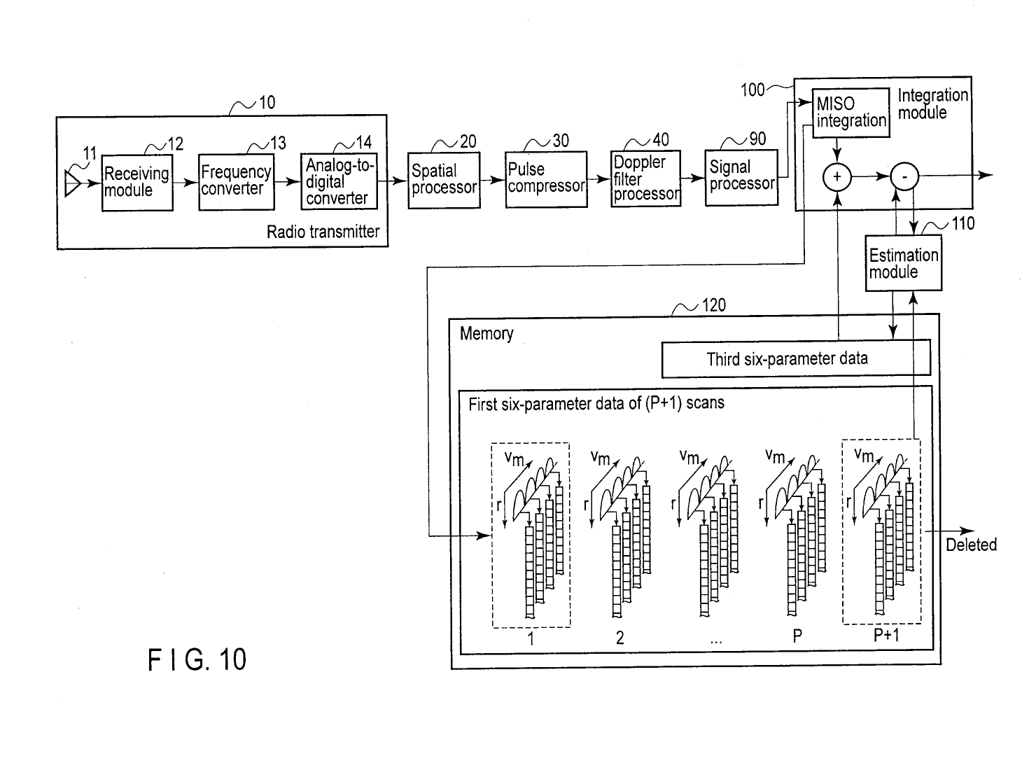

Each radar equipment receives pulse signals, which are transmitted from transmitters TX1-TXR as outgoing pulses and, for example, reflected by a target. The outgoing pulses transmitted from the transmitters TX1-TXR are pulses modulated to be uncorrelated to each other. The radar equipments share the origin and orthogonal axes of coordinates. FIG. 10 is a block diagram showing another functional configuration of the radar equipment according to the first embodiment.

The radar equipment shown in FIG. 10 comprises a radio transmitter 10, a special processor 20, a pulse compressor 30, a Doppler filter processor 40, a signal processor 90, an integration module 100, an estimation module 110 and a memory 120.

The signal processor 90 records the origin and orthogonal axes of coordinates in advance. Further, the signal processor 90 keeps the positional coordinates of the radar equipment including the signal processor 90. The signal processor 90 makes the status of a predetermined search area expressed by the x-, y-, and z-positional coordinates of a target and the magnitudes of the x-, y-, and z-directional components of the velocity of the target, based on range bin data supplied from the Doppler filter processor 40. Namely, the signal processor 90 generates first six-parameter data F (x, y, z, vₓ, v_{y}, v_{z}) so that the amplitude value of range cell data can be identified by the x-, y-, and z-positional coordinates of a target and the magnitudes of the x-, y-, and z-directional components of the velocity of the target. The signal processor 90 outputs the first six-parameter data to the integration module 100.

When the estimation module 110 receives second six-parameter data (to be described later) from the integration module 100, the estimation module 110 assumes that a target is present in all the elements of second six-parameter data. The estimation module 110 estimates a range bin in which the target would be present when a next scan is performed, on the basis of the velocity, which is a parameter of the second six-parameter data. Assuming that a target moves with uniform linear motion, when first six-parameter data of a time is F (x, y, z, vₓ, v_{y}, v_{z}), six-parameter data of At seconds later is estimated to be F (x+vₓT_{SCAN}, y+v_{y}T_{SCAN}, z+v_{z}T_{SCAN}, vₓ, v_{y}, v_{z}). Namely, when the interval between adjacent range bins is d, the target moves by range bins, the number of which is the maximum integer (Δnₓ, Δn_{y}, Δn_{z}) not more than (vₓT_{SCAN}/d, v_{y}T_{SCAN}/d, v_{z}T_{SCAN}/d).

The estimation module 110 shifts second six-parameter data by (Δnₓ, Δn_{y}, Δn_{z}) range bins to the estimated range bin to generate third six-parameter data. The estimation module 110 outputs the generated third six-parameter data to the memory 120.

The estimation module 110 receives first six-parameter data recorded at the time of a predetermined p^{th} previous scan (where p is a natural number). The estimation module 110 estimates a range bin in which a target would be present at the p^{th} next scan (T_{SCAN}×p seconds later), that is, the present scan. The estimation module 110 shifts the first six-parameter data recorded at the time of the p^{th} previous scan to the estimated range bin to generate fourth six-parameter data. The estimation module 110 outputs the generated fourth six-parameter data to the integration module 100.

The memory 120 receives first six-parameter data after MISO integration (to be described later) from the integration module 100. The memory 120 stores the (p+1) first six-parameter data items supplied from the integration module 100. More specifically, the memory 120 first stores first six-parameter data items obtained by the first to p^{th} scans and subjected to MISO integration. After the memory 120 stores the (p+1)^{th} first six-parameter data item at the time of the (p+1)^{th} scan, the memory 120 outputs the first six-parameter data item stored at the time of the first scan to the estimation module 110, and deletes the first six-parameter data item stored at the time of the first scan. If a first six-parameter data item is obtained at the time of a (p+2)^{th} or later scan, the memory 120 outputs the first six-parameter data item stored at the time of the p^{th} previous scan to the estimation module 110, and deletes the first six-parameter data item stored at the time of the p^{th} previous scan.

The memory 120 also stores third six-parameter data supplied from the estimation module 110. The memory 120 outputs stored third six-parameter data to the integration module 100 in accordance with read instructions from the integration module 100.

The integration module 100 performs multiple-input single-output (MISO) integration on first six-parameter data supplied from the signal processor 90. The MISO integration is processing of integrating first six-parameter data of pulse signals based on a plurality of outgoing pulses. The pulse signals are outgoing pulses reflected, scattered, or diffracted by the same target. The MISO integration of first six-parameter data will be described below.

The transmitters TX1-TXR direct a transmission beam to a target at different times. Therefore, the pulse signals corresponding to the outgoing pulses transmitted from the transmitters TX1-TXR are received by a radar equipment at different times. Further, since the transmitters TX1-TXR direct a transmission beam to a target at different times, the target may move between the times. Therefore, the first six-parameter data obtained based on the pulse signals from the same target varies from one transmission source to another.

The integration module 100 predetermines a movement model of a target, and estimates a degree of movement of the target from the time when one transmitter directs a transmission beam to the target to the time when another transmitter directs a transmission beam to the target, based on the predetermined movement model. For example, assuming that the movement model of a target is uniform linear motion, when first six-parameter data of a time is F (x, y, z, vₓ, v_{y}, v_{z}), first six-parameter data of Δt seconds later is estimated to be F (x+vₓΔt, y+v_{y}Δt, z+v_{z}Δt, vₓ, v_{y}, v_{z}).

Based on the difference between signal receipt times and predetermined movement model, the integration module 100 estimates first six-parameter data at a later receipt time from first six-parameter data obtained based on a pulse signal received earlier. The integration module 100 integrates the amplitude value of first six-parameter data obtained based on a pulse signal received later with the amplitude value of the estimated first six-parameter data. Accordingly, the receipt times of the pulse signals, which are transmitted from the transmitters TX1-TXR as outgoing pulses and reflected by the same target, are different from each other, but the integration module 100 can integrate amplitude values of first six-parameter data items of different transmission sources.

At the time of the first scan, the integration module 100 outputs first six-parameter data after MISO integration to the processing server 130 and the estimation module 110 as second six-parameter data.

At the time of each of the second to p^{th} scan, upon receipt of first six-parameter data after MIMO integration, the integration module 100 reads from the memory 120 third six-parameter data generated based on the previous scan. The integration module 100 integrates the first six-parameter data after MISO integration with the third six-parameter data read out from the memory 120 to generate second six-parameter data. The integration module 100 outputs the generated second six-parameter data to the processing server 130 and the estimation module 110.

At the time of a (p+1)^{th} or later scan, the integration module 100 integrates first six-parameter data after MISO integration with third six-parameter data supplied from the memory 120. Then, the integration module 100 subtracts fourth six-parameter data supplied from the estimation module 110 from the integration result to generate second six-parameter data.

The processing server 130 performs single-input multiple-output (SIMO) integration on second six-parameter data obtained at the connected radar equipments. The processing server 130 determines that a target is detected when the amplitude value of the result of the SIMO integration exceeds a threshold value set in accordance with the number of integration operations in the SIMO integration.

When integration of first six-parameter data is performed a predetermined p times or more, the integration module 100 subtracts fourth six-parameter data estimated based on the first six-parameter data obtained by the p^{th} previous scan from the integration result. Namely, the number of incoherent integration operations is limited to a predetermined number. Therefore, even in the case where radar equipments form a MIMO radar system, continuous effect of a past high noise signal on search processing in later scans can be suppressed.

### Second Embodiment

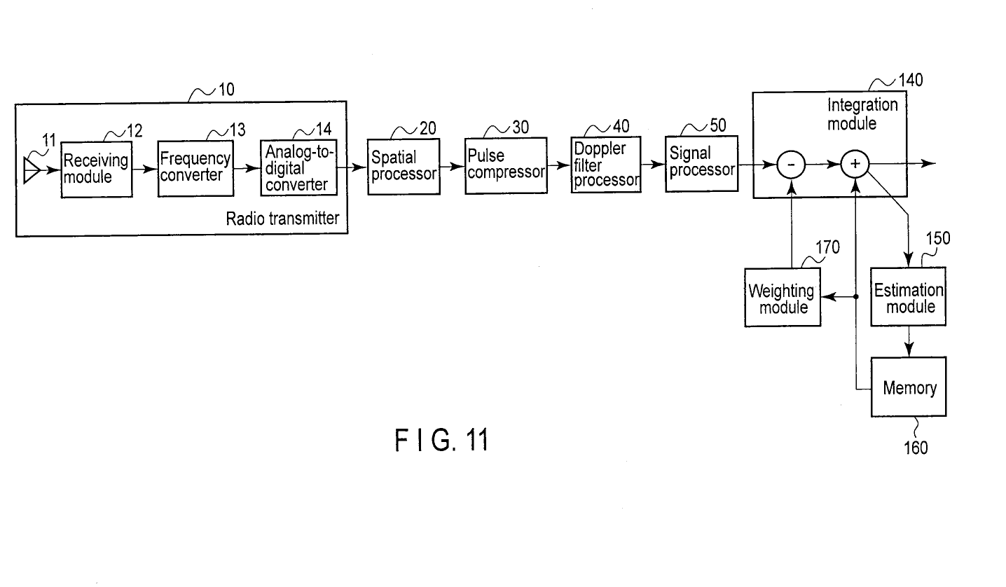

FIG. 11 is a block diagram showing a functional configuration of a radar equipment according to a second embodiment. The radar equipment shown in FIG. 11 comprises a radio transmitter 10, a spatial processor 20, a pulse compressor 30, a Doppler filter processor 40, a signal processor 50, an integration module 140, an estimation module 150, a memory 160, and a weighting module 170.

The signal processor 50 generates first four-parameter data identifying the amplitude value of range bin data supplied from the Doppler filter processor 40 by range r, azimuth angle θ, elevation angle φ, and relative velocity vₘ. The signal processor 50 outputs the generated first four-parameter data to the integration module 140.

When the estimation module 150 is supplied with second four-parameter data (to be described later) by the integration module 110, the estimation module 150 estimates a range bin in which the target indicated by the second four-parameter data would be present when a next scan is performed. The estimation module 150 shifts the second four-parameter data to the estimated range bin to generate third four-parameter data. The estimation module 150 outputs the generated third four-parameter data to the memory 160.

The memory 160 stores third four-parameter data supplied from the estimation module 150. The memory 160 outputs stored third four-parameter data to the integration module 140 and the weighting module 170 in accordance with read instructions from the integration module 140.

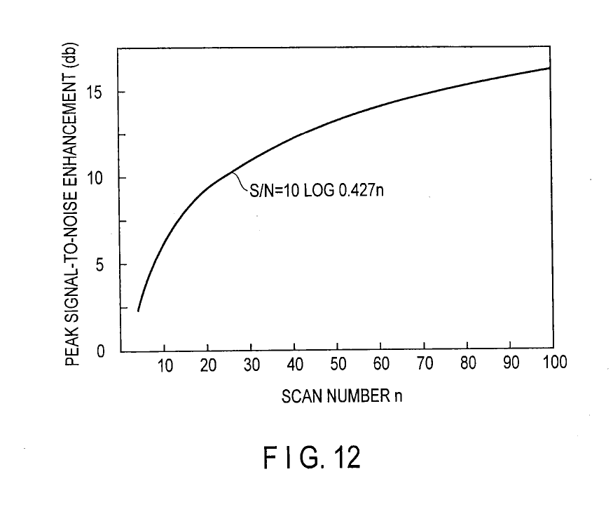

A weighting coefficient K is preset in the weighting module 170. The weighting coefficient K is given by K−1−1.56/n, where n is a scan number. FIG. 12 shows signal-to-noise ratio characteristic change (integration characteristic) of the case where a target signal is subjected to incoherent integration relative to the scan number. The weighting module 170 multiples the third four-parameter data supplied from the memory 160 by (1−K) to generate fourth four-parameter data, and outputs the fourth four-parameter data to the integration module 140.

At the time of the first scan, the integration module 140 outputs first four-parameter data supplied from the signal processor 50 to the subsequent stage and the estimation module 150 as second four-parameter data.

At the time of the second or later scan, upon receipt of first four-parameter data from the signal processor 50, the integration module 140 reads out from the memory 160 third four-parameter data generated based on the previous scan. The integration module 140 subtracts fourth four-parameter data supplied from the weighting module 170 from the first four-parameter data supplied from the signal processor 50. The integration module 140 integrates the subtraction result with the third four-parameter data read from the memory 160 to generate second four-parameter data, and outputs the second four-parameter data to the subsequent stage and the estimation module 150.

As described above, the radar equipment according to the second embodiment subtracts fourth four-parameter data weighted by the weighting module 170 from first four-parameter data from the signal processor 50, and adds third four-parameter data estimated based on the previous scan to the data after subtraction. Namely, the radar equipment adopts a phasing memory method using a sweep integrator, which is a method of a moving target indication (MTI) system for removing a disturbing signal component or the like. Therefore, continuous effect of a past high noise signal on search processing in later scans can be suppressed. Further, the radar equipment obviates the need for holding (P+1) first four-parameter data items required for sliding window processing described in the first embodiment, thereby enabling saving of memory.

Consequently, the radar equipment according to the second embodiment can suppress effect of a noise signal occurred in a past scan, and correctly detect the position of a target.

Described in the second embodiment is the case where the signal processor 50 converts range bin data supplied from the Doppler filter processor 40 into four-parameter data. However, the radar equipment may have different configurations. For example, the radar equipment may form a MIMO radar system as shown in FIG. 9.

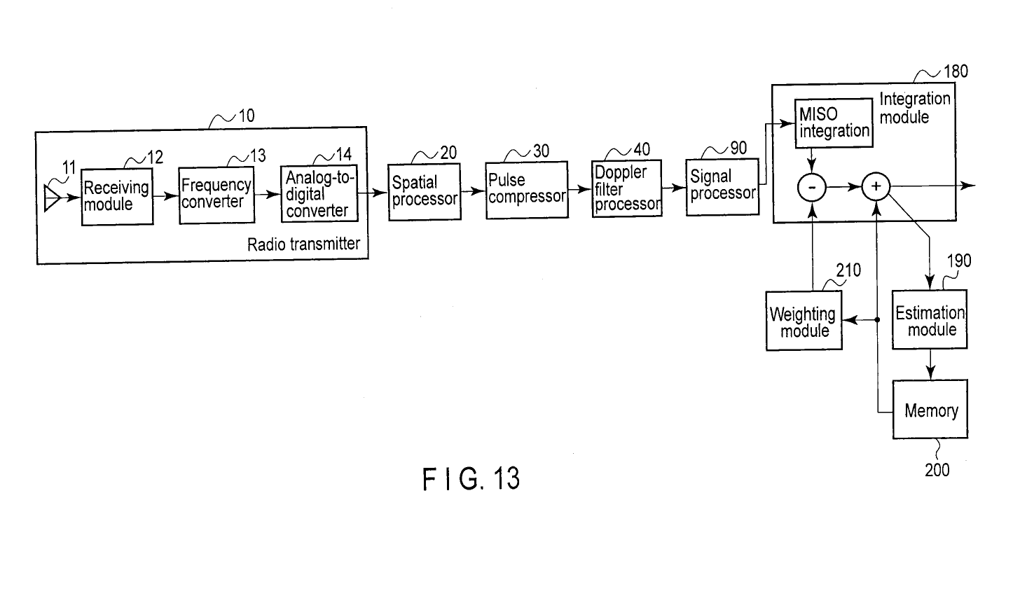

Each radar equipment receives pulse signals, which are transmitted from transmitters TX1-TXR as outgoing pulses and, for example, reflected by a target. FIG. 13 is a block diagram showing another functional configuration of the radar equipment according to the second embodiment.

The radar equipment shown in FIG. 13 comprises a radio transmitter 10, a special processor 20, a pulse compressor 30, a Doppler filter processor 40, a signal processor 90, an integration module 180, an estimation module 190, a memory 200 and a weighting module 210.

The signal processor 90 generates first six-parameter data based on a range bin data supplied from the Doppler filter processor 40, and outputs the generated first six-parameter data to the integration module 180.

When the estimation module 190 receives second six-parameter data (to be described later) from the integration module 180, the estimation module 190 assumes that a target is present in all the elements of second six-parameter data. The estimation module 190 estimates a range bin in which the target would be present when a next scan is performed, on the basis of the velocity, which is a parameter of the second six-parameter data. The estimation module 190 shifts second six-parameter data by (Δnₓ, Δn_{y}, Δn_{z}) range bins to the estimated range bin to generate third six-parameter data. The estimation module 190 outputs the generated third six-parameter data to the memory 200.

The memory 200 stores third six-parameter data supplied from the estimation module 190. The memory 200 outputs stored third six-parameter data to the integration module 180 and the weighting module 210 in accordance with read instructions from the integration module 180.

A weighting coefficient K is preset in the weighting module 210. The weighting coefficient K is given by K=1−1.56/n, where n is a scan number. The weighting module 210 multiples the third four-parameter data supplied from the memory 200 by (1−K) to generate fourth six-parameter data, and outputs the fourth six-parameter data to the integration module 180.

The integration module 180 performs MISO integration on the first six-parameter data supplied from the signal processor 90.

At the time of the first scan, the integration module 180 outputs first six-parameter data after MISO integration to the processing server 130 and the estimation module 190 as second six-parameter data.

At the time of the second or later scan, upon receipt of first six-parameter data after MISO integration, the integration module 180 reads out from the memory 200 third six-parameter data generated based on the previous scan. The integration module 180 subtracts fourth six-parameter data supplied from the weighting module 210 from the first six-parameter data after MISO integration. The integration module 180 integrates the subtraction result with the third six-parameter data read from the memory 200 to generate second six-parameter data, and outputs the second six-parameter data to the processing server 130 and the estimation module 190.

Accordingly, the integration module 180 subtracts fourth six-parameter data weighted by the weighting module 210 from the first six-parameter data after MISO integration, and adds third six-parameter data estimated based on the previous scan to data after subtraction. Therefore, even in the case where radar equipments form a MIMO radar system, continuous effect of a past high noise signal on search processing in later scans can be suppressed. Further, the configuration obviates the need for holding (P+1) first four-parameter data items required for sliding window processing described in the first embodiment, thereby enabling saving of memory.

Described in each of the above-described embodiments is the case where the estimation module 70, 110, 150, 190 generates third data or third six-parameter data of a next scan based on second four-parameter data or second six-parameter data, and the memory 80, 120, 160, 200 stores the generated data. However, the radar equipment may have different configurations. For example, the radar equipment may have a configuration in which the integration module 60, 100, 140, 180 causes the second four-parameter data or second six-parameter data to be stored in the memory, and the estimation module 70, 110, 150, 190 reads out the second data or second six-parameter data from the memory when new first data or first six-parameter data is generated, and generates third data or third six-parameter data based on the read second data or second six-parameter data.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radar equipment, comprising:
a radio transmitter configured to receive pulse signals;
a pulse compressor configured to perform pulse compression on the pulse signals to generate range bin data for each of the pulse signals;
a Doppler filter processor configured to perform Doppler filter processing on the range bin data to generate range bin data for each frequency bin;
a signal processor configured to generate first data indicating a state of a predetermined search area using parameters including a velocity of a target, based on the range bin data for each frequency bin obtained by one scan to the search area;
a first estimation module configured to estimate a position of the target at a time of a present scan based on second data obtained by integrating first data of a predetermined number n of most recent previous scans, and shift the second data to the estimated position to generate third data;
a second estimation module configured to estimate a position of the target at the time of the present scan based on first data obtained by an n^{th} previous scan, and shift the first data of the n^{th} previous scan to the estimated position to generate fourth data; and
an integration module configured to add the third data to first data obtained by the present scan to generate addition data, and subtract the fourth data from the addition data to generate second data.

2. The radar equipment of claim 1, wherein the first data is first four-parameter data indicating the state of the search area using a range, an azimuth angle, an elevation angle, and a relative velocity of the target calculated based on the frequency bin.

3. The radar equipment of claim 1, wherein
the pulse signals are a plurality of outgoing pulses modulated to be uncorrelated to one another, and reflected, scattered or diffracted, and received, and
the first data is first six-parameter data indicating the state of the search area using coordinates in a Cartesian coordinate system with a preset origin and orthogonal axes, and velocity components of a target in the Cartesian coordinate system.

4. A radar equipment, comprising:
a radio transmitter configured to receive pulse signals;
a pulse compressor configured to perform pulse compression on the pulse signals to generate range bin data for each of the pulse signals;
a Doppler filter processor configured to perform Doppler filter processing on the range bin data to generate range bin data for each frequency bin;
a signal processor configured to generate first data indicating a state of a predetermined search area using parameters including a velocity of a target, based on the range bin data for each frequency bin obtained by one scan to the search area;
an estimation module configured to estimate a position of the target at a time of a present scan based on second data obtained by integrating first data of previous scans by a predetermined system, and shift the second data to the estimated position to generate third data;
a weighting module configured to weight the third data with a predetermined coefficient to generate fourth data; and
an integration module configured to subtract the fourth data from first data obtained by the present scan to generate subtraction data, and add the third data to the subtraction data to generate second data.

5. The radar equipment of claim 4, wherein the first data is first four-parameter data indicating the state of the search area using a range, an azimuth angle, an elevation angle, and a relative velocity of the target calculated based on the frequency bin.

6. The radar equipment of claim 4, wherein
the pulse signals are a plurality of outgoing pulses modulated to be uncorrelated to one another, and reflected, scattered or diffracted, and received, and
the first data is first six-parameter data indicating the state of the search area using coordinates in a Cartesian coordinate system with a preset origin and orthogonal axes, and velocity components of a target in the Cartesian coordinate system.

7. A received data processing method, comprising:
receiving pulse signals;
performing pulse compression on the pulse signals to generate range bin data for each of the pulse signals;
perform Doppler filter processing on the range bin data to generate range bin data for each frequency bin;
generating first data indicating a state of a predetermined search area using parameters including a velocity of a target, based on the range bin data for each frequency bin obtained by one scan to the search area;
estimating a position of the target at a time of a present scan based on second data obtained by integrating first data of a predetermined number n of most recent previous scans, and shifting the second data to the estimated position to generate third data;
estimating a position of the target at the time of the present scan based on first data obtained by an n^{th} previous scan, and shifting the first data of the n^{th} previous scan to the estimated position to generate fourth data;
adding the third data to first data obtained by the present scan to generate addition data; and
subtracting the fourth data from the addition data to generate second data.

8. A received data processing method, comprising:
receiving pulse signals;
performing pulse compression on the pulse signals to generate range bin data for each of the pulse signals;
performing Doppler filter processing on the range bin data to generate range bin data for each frequency bin;
generating first data indicating a state of a predetermined search area using parameters including a velocity of a target, based on the range bin data for each frequency bin obtained by one scan to the search area;
estimating a position of the target at a time of a present scan based on second data obtained by integrating first data of previous scans by a predetermined system, and shifting the second data to the estimated position to generate third data;
weighting the third data with a predetermined coefficient to generate fourth data;
subtracting the fourth data from first data obtained by the present scan to generate subtraction data; and
adding the third data to the subtraction data to generate second data.
